(19) United States
(12) Patent Application Publication
(10) Pub. No.: US 2007/0006952 A1
(43) Pub. Date: Jan. 11, 2007

(54) Pneumatic tire

(75) Inventors: Ichiro Shima, Osaka-shi (JP); Van Quang Doan, Osaka-shi (JP)

Correspondence Address: JORDAN AND HAMBURG LLP, 122 EAST 42ND STREET, SUITE 4000, NEW YORK, NY, 10168, US

(73) Assignee: Toyo Tire & Rubber Co., Ltd., Osaka-shi (JP)

(21) Appl. No.: 11/476,996

(22) Filed: Jun. 13, 2006

(30) Foreign Application Priority Data
Jun. 13, 2005 (JP) 2005-172709

(51) Int. Cl. B60C 11/00

(52) U.S. Cl. 152/209.1

(57) ABSTRACT

There is provided a pneumatic tire including cross grooves which are provided on a tread portion in such a manner as to cross each other in an X shape, as well as cross each other symmetrically with respect to a tire transverse line, wherein assuming that a point of intersection between a tire circumferential line which passes through a point of intersection A of the cross grooves and a tire contact patch shaping line is a point of intersection B, a crossing angle of the cross grooves which lie to hold therebetween a tire transverse line which passes through the point of intersection A is θα, and an angle made by a tire circumferential line which passes through the point of intersection B and a tangential line to the tire contact patch shaping line at the point of intersection B is θβ, the cross grooves satisfy the following conditions:
when θβ<45°, θα<−2.5×θβ+162.5° 1)
when 45°≦θβ<60°, θα>−1.2×θβ+179° 2)
when 60°≦θβ≦90°, θα>105°. 3)

### CROSS-REFERENCE TO RELATED APPLICATIONS

This application is based upon and claims the benefit of priority from the prior Japanese Patent Application No. 2005-172709, filed on Jun. 13, 2005; the entire contents of which are incorporated herein by reference.

### BACKGROUND OF THE INVENTION

1. Field of the Invention

The present invention relates to a pneumatic tire, and more particularly to a pneumatic tire with a tread pattern having a superior noise control performance.

2. Description of the Related Art

As one of causes for pneumatic tire noise generated while running, there has been known a so-called pattern noise such as pumping noise, pattern vibration noise and the like. When grooves formed on a tread of a tire to make up a tread pattern enter a contact patch area, air is trapped and compressed in the grooves, and when the grooves leave the contact patch area, the air so trapped and compressed in the grooves is released. The pumping noise is a noise generated when the compressed air is so released. On the other hand, at the contact patch area, the tread pattern is brought into collision with the road surface, and the tire is vibrated by impact resulting from the collision. The pattern vibration noise is a noise generated by virtue of the vibration of the tire.

Among the pattern noises, particularly, in the pattern vibration noise, a frequency component (a primary component) that is determined by the number of pitches and rotational speed of a tire appears remarkably. Here, the pitch of the tire means a minimum unit of a pattern, making up a tread pattern, which is repeatedly formed on a tread portion of the tire in a circumferential direction thereof.

Conventionally, in order to reduce the pattern vibration noise, efforts have been made to reduce the impact generated when the tread pattern is brought into contact with the road surface. For example, there have been proposed a method for reducing the rigidity of individual pattern blocks by increasing the number of tire pattern pitches and a method for making uniform fluctuations in tread rigidity occurring when the tire rolls by reducing the void ratio (a ratio of sea portions to land portions in a tread pattern which is made up of land portions and sea portions). In addition, there is also known a method for dispersing the frequency of the pattern vibration noise by adopting a pitch arrangement in which individual pitch lengths of the tread pattern are changed or improving the tone of a noise generated in the time axis (for example, refer to the Japanese Patent Application Kokai No. 2003-136914).

In addition, when increasing the noise control performance of tires, the water drainage properties should not be sacrificed. In other words, the noise control performance is required to be compatible with the water drainage properties, and to make this happen, a variety of technical proposals have been made. For example, the Japanese Patent Application Kokai No. 6-55913 proposes a technique in which a tread portion is first divided into a plurality of land portions which continue in a circumferential direction of a tire by a plurality of main grooves, then sipes are provided in the tread portion which extend in an S-shape continuously or intermittently from one side to the other side of the tread portion, and lug grooves are provided to extend on the sipes and in a direction which intersects the sipes. In addition, the Japanese Patent Application Kokai No. 9-207522 proposes a technique in which left and right main lug grooves are provided which expand into a V-shape from a central portion of a tread portion, and left and right auxiliary lug grooves are provided in such a manner as to cross the main lug grooves, so that a number of blocks are formed in such a manner as to be divided by the main lug grooves and the auxiliary lug grooves. Additionally, the Japanese Patent Application Kokai No. 9-240219 discloses a technique in which a main circumferential longitudinal groove is provided at a central area of a tread portion, then transverse grooves are provided in an intermediate area and shoulder areas without providing circumferential longitudinal grooves, and sipes are provided in such a manner as to cross the transverse grooves which are inclined in the intermediate area.

### SUMMARY OF THE INVENTION

Irrespective of the aforesaid conventional methods, the reduction in pattern vibration noise is not easy in tread pattern configurations which make it difficult to adopt pitch arrangements which allow for an increase in the number of tire pitches and variable pitch lengths due to design limitations and other properties required for tires.

For example, currently, in order to improve the appearance of tires with novel designs, pneumatic tires are now under development in which cross grooves are formed in a tread portion in such a manner as to cross each other in an X shape, as well as be symmetrical with each other relative to a transverse line of the tire. An example of the cross grooves is shown in FIGS. 5A and 5B. As shown therein, in a configuration in which two grooves 1, 2 lying on a tire pattern cross each other in the X shape, assuming that with the circumferential direction of the tire being 0°, relative angles of the individual grooves 1, 2 to a line drawn in a width direction of the tire or tire transverse line Lw which is a 90° line passing a point of intersection A of the two grooves 1, 2 are θ1, θ2, θ3, and θ4, respectively, the cross grooves are such as to be configured to establish θ1=θ2=θ3=θ4. Conventionally, while there is known a tread pattern in which grooves and sipes cross in the X shape like this (for example, refer to the Japanese Patent Application Kokai No. 9-240219), there has been known no tread pattern in which grooves are made to cross each other in the symmetrical X shape. In the pattern configuration which adopts these cross grooves, since the length of a pitch in the circumferential direction of the tire becomes long, there is imposed a limitation on the number of pitches and setting of pitch arrangement.

An object of the invention is to provide a pneumatic tire with a tread pattern including the novel cross grooves which has a superior noise control performance.

As a result of through studies made with a view to accomplishing the object, the inventors found that the object can be accomplished to reduce the level of noise by limiting the crossing angle of cross grooves to a specific range, managing to complete the invention successfully.

Namely, according to a first aspect of the invention, there is provided a pneumatic tire including cross grooves which are provided on a tread portion of the tire in such a manner as to cross each other in an X shape, as well as cross each other substantially symmetrically with respect to a tire transverse line, wherein assuming that a point of intersection between a tire circumferential line which passes through a point of intersection A of the cross grooves and a tire contact patch shaping line is a point of intersection B, a crossing angle of the cross grooves which lie to hold therebetween a tire transverse line which passes through the point of intersection A is θα, and an angle made by a tire circumferential line which passes through the point of intersection B and a tangential line to the tire contact patch shaping line at the point of intersection B is θβ, the cross grooves are provided to satisfy 60°≦θβ≦90° and θα>105°.

According to a second aspect of the invention, there is provided a pneumatic tire including cross grooves which are provided on a tread portion of the tire in such a manner as to cross each other in an X shape, as well as cross each other substantially symmetrically with respect to a tire transverse line, wherein assuming that a point of intersection between a tire circumferential line which passes through a point of intersection A of the cross grooves and a tire contact patch shaping line is a point of intersection B, a crossing angle of the cross grooves which lie to hold therebetween a tire transverse line which passes through the point of intersection A is θα, and an angle made by a tire circumferential line which passes through the point of intersection B and a tangential line to the tire contact patch shaping line at the point of intersection B is θβ, the cross grooves are provided in at least one of the following areas defined 1) to 3) below and have a crossing angle θαwhich satisfies expressions given for the areas where the grooves are provided.
area of θβ<45°: θα<−2.5×θβ+162.5° 1)
area of 45°≦θβ<60°: θα>−1.2×θβ+179° 2)
area of 60°≦θβ≦90°: θα>105° 3)

According to the invention, in the pneumatic tire with the tread pattern including the cross grooves, the pattern vibration noise can be reduced, and hence, the pneumatic tire can be provided which has a superior noise control performance. In addition, the pneumatic tire is such that the crossing angle is set to be within a predetermined range according to a position where the cross grooves are provided in order to reduce the pattern vibration noise, and since there is no need to change the void ratio which is a ratio of sea portions to land portions in the tread pattern, thereby making it possible to reduce the level of noise without sacrificing the water drainage properties.

### BRIEF DESCRIPTION OF THE DRAWINGS

FIG. 1 is a partial development which shows a tread pattern of a pneumatic tire according to a first embodiment of the invention.

FIG. 2 is an enlarged view of a main part of FIG. 1.

FIG. 3 is a drawing which shows a tread pattern image.

FIG. 4 is a graph which shows the results of an analysis using a tread pattern area fluctuation calculating method.

FIG. 5A is a schematic drawing of a tread pattern which shows a configuration example of cross grooves, and FIG. 5B is an enlarged view of a main part thereof.

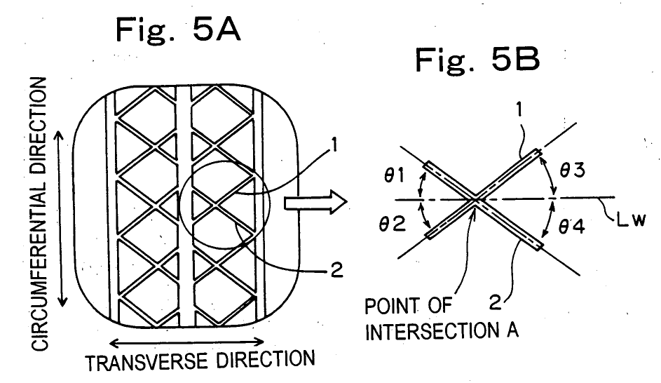

FIG. 6 is a partial development which shows a tread pattern of a pneumatic tire according to a second embodiment of the invention.

### DETAILED DESCRIPTION OF THE INVENTION

Hereinafter, embodiments of the invention will be described by reference to the accompanying drawings.

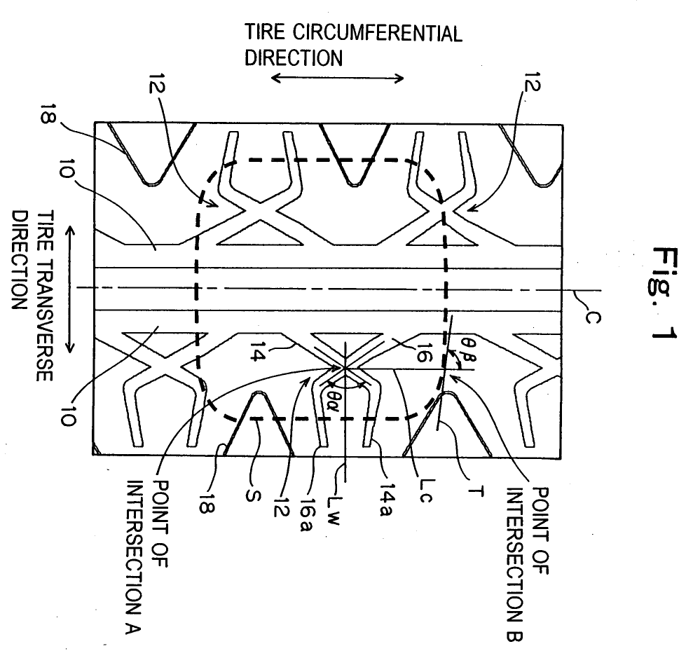

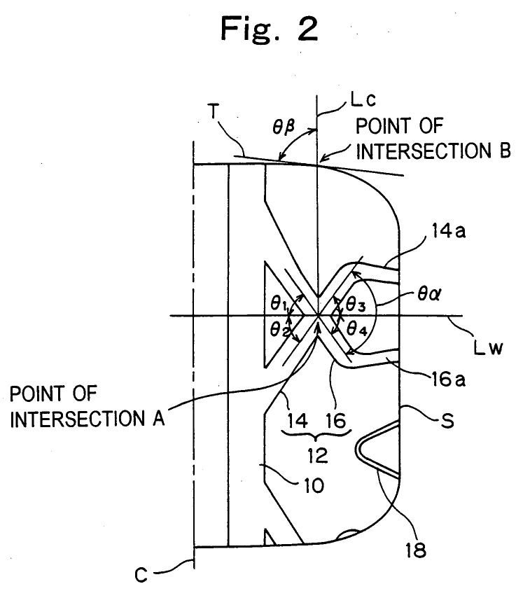

FIG. 1 is a drawing which shows a planar development of part of a tread pattern of a pneumatic tire according to a first embodiment of the invention, and FIG. 2 is an enlarged view of part of the tread pattern so developed. This pneumatic tire includes circumferential main grooves 10 which extend in a circumferential direction of the tire. In this embodiment, two main grooves 10 are provided in parallel at a transversely central portion of a tread portion.

In addition, cross grooves 12 which cross each other in an X shape are also provided in the tread portion. The cross grooves 12 are provided on both sides of the two main grooves 10 in such a manner as to open to each main groove 10, and a plurality of cross grooves 12 are provided at predetermined intervals in the circumferential direction of the tire. The cross grooves 12 are made up of a first groove 14 which extends outwards in the transverse direction of the tire from the main groove 10 in such a manner as to incline relative to the circumferential direction of the tire and a second groove 16 which extends outwards in the transverse direction of the tire from the same main groove 10 in such a manner as to incline in an opposite direction to the first groove 14 so as to cross the first groove 14, and the cross grooves are made when the first groove 14 and the second groove 16 cross each other at a symmetrical angle with respect to a line drawn in the transverse direction of the tire or tire transverse line Lw. To be specific, the cross grooves 12 are formed in such a manner as to be symmetrical when they are folded with respect to the tire transverse line Lw which passes through a point of intersection A between the first groove 14 and the second groove 16 (namely, line symmetry). In addition, assuming that a circumferential direction (a turning direction) of the tire is 0°, the tire transverse line Lw is a line which is parallel to a tire width direction which makes an angle of 90° with the circumferential direction. In addition, the groove width of these grooves 14, 16 is 2 mm or greater, and it is normally in the range of 2 to 15 mm.

To describe in greater detail, assuming that angles made by the tire transverse line Lw which passes through a point of intersection A and the individual grooves 14, 16 are, as shown in FIG. 2, θ1, θ2, θ3, and θ4, the cross grooves 12 are configured so as to establish a relationship of θ1=θ2=θ3=θ4. Here, θ1 to θ4 do not have to be completely the same but may be substantially the same, and they are regarded as the same provided they fall within a range of ±5°. In addition, in the invention, the angle of grooves is defined by an angle made by width direction center lines of the grooves 14, 16.

In this embodiment, the first groove 14 and the second groove 16 are not consistent in groove width and are formed in such a manner that the groove width gradually narrows as they extend towards distal ends thereof. In addition, the cross grooves 12 are formed to be bent outwards in the transverse direction of the tire in shoulder areas of the tread portion. Namely, the fist groove 14 and the second groove 16 bend after they have crossed each other in the X shape, as has been described before, to thereby have transverse groove potions 14a, 16a which extend substantially in parallel with each other towards the transverse direction of the tire, specifically speaking, these transverse grooves 14a, 16a inclining inwards to approach each other to thereby slightly narrow a space therebetween as the grooves extend to their distal ends. Thus, the cross grooves 12 may only have to have the X-shaped crossing portion and can adopt various groove configurations on both sides of the crossing portion. In addition, in the embodiment, while the cross grooves 12 are provided on both the sides of the main grooves 10, the cross grooves 12 may be provided only one side of the main grooves 10 and only circumferential grooves may be provided on the other side thereof.

As shown in FIG. 1, sipes 18 are provided in the tread portion. Here, the sipe 18 means a cut or incision whose width is 1.8 mm or less, and the sipes 18 are to be clearly distinguished from grooves which make up the cross grooves 12. The sipe 18 is formed into a V shape which extends outwards in the transverse direction of the tire while expanding longitudinally in the circumferential direction of the tire in the shoulder areas of the tread portion, and the sipes 18 are provided alternately with the cross grooves 12 in the circumferential direction of the tire.

In the embodiment, in the pneumatic tire with the tread pattern that has just been described, in order to increase the noise control performance without sacrificing the water drainage properties, the cross grooves 12 are configured as below. Namely, assuming that a point of intersection between a tire circumferential line Lc which passes through a point of intersection A of the cross grooves 12 and a tire contact patch shaping line S is a point of intersection B, a crossing angle of the cross grooves 12 which lie to hold therebetween a tire transverse line Lw which passes through the point of intersection A is θα, and an included angle made by a tire circumferential line Lc which passes through the point of intersection B and a tangential line T tangent to the tire contact patch shaping line S at the point of intersection B is θβ, the cross grooves 12 are provided to satisfy the following conditions:
when θβ<45°, θα<−2.5×θβ+162.5° 1)
when 45°≦θβ<60°, θα>−1.2×θβ+179° 2)
when 60°≦θβ≦90°, θα>105° 3)

Where, the tire circumferential line Lc denotes a line parallel to the circumferential direction of the tire, and the tire contact patch shaping line S is a contour line of a tread contact patch shape formed when a tire is loaded with a service air pressure or tire inflation pressure and load prescribed according to tire sizes under the standard of JATMA (Japanese Automobile Tire Manufactures Association).

The aforesaid conditions are such as to be obtained through analysis by applying to the cross grooves 12 the tread pattern area fluctuation calculating method which uses the image processing method described the Japanese Patent Application Kokai No. 2003-136914, and the details thereof will be described as below.

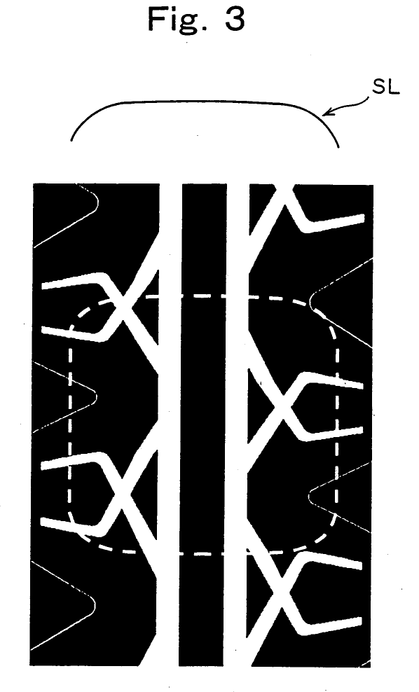

A computer such as a personal computer was used for the analysis. Firstly, a tread pattern was prepared through CAD, then an analysis pattern drawing (refer to FIG. 1) was prepared based on the pattern drawing prepared through CAD, a metafile for the analysis pattern drawing so prepared was prepared. Following this, missing portions of the image due to the metafile were corrected, and a contact portion, a non-contact portion and an edge portion were distinguished from each other in different colors. FIG. 3 shows an image resulting from the color distinguishing process, a portion indicated black is the contact portion, and portion indicated while is the non-contact portion. In addition, in FIG. 3, while the tire contact patch shaping line S is indicated by a while dotted line, this line does not exist in the image resulting after the actual color distinguishing process.

Next, a contact patch pattern was defined and inputted. The contact patch pattern is defined by a contact line (denoted by a reference character SL in FIG. 3) that is formed when the tire begins to contact the road surface among the tire contact patch shaping line S. This contact patch pattern was scanned along the circumferential direction of the tire over a distance equal to one full revolution of the tire, and tire contact area fluctuation data were obtained. The contact area is obtained by counting the number of pixels of contact portions residing on the contact patch pattern. The contact area fluctuation data was frequency analyzed, and a total sum of energy levels in a frequency band of 360 to 560 Hz was calculated as a fluctuation level of the tread pattern. Note that the running speed of the tire was 60 km/h.

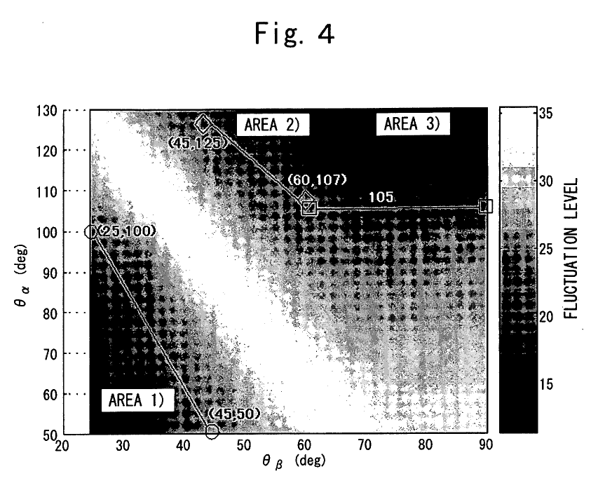

The calculation of the fluctuation level was carried out in ranges of θα=50° to 130°, θβ=25° to 90° while changing the θα and θβ by 1°, respectively. The results of the calculation are shown in FIG. 4. In FIG. 4, the angle θβ which constitutes an index for the position of the cross grooves was represented on the axis of abscissa and the crossing angle θα of the gross grooves was represented on the axis of ordinates, and the fluctuation level of the each tread pattern which is determined by θα and θβ was indicated on gray scale. Since the noise control level becomes more superior as the fluctuation level decreases further (as the color gets darker), it is seen in a graph shown in FIG. 4 that a combination of θα and θβ which provides for a superior noise control performance exists in a top right-hand side area and a bottom left-hand side area. The fluctuation level calculation was also carried out on commercially marketed pneumatic tires exhibiting a superior noise control performance, and it was found from the results of the calculations and what is shown in the graph of FIG. 4 that the cross grooves may only have to be set to satisfy the aforesaid conditions 1) to 3) in order to secure a noise control performance equal to or better than the commercially marketed pneumatic tires.

In the conditions under 1) to 3) above, a range that θα can take is preferably not less than 30° and not more than 150°. In the event that θα gets out of this range, although depending on the groove width of the first groove 14 and the second groove 16, an acute angle made by the cross grooves 12 becomes sharp, making the cross grooves 12 impractical.

In addition, as is estimated from the graph shown in FIG. 4, while even in the event that the condition on θα in 2) is satisfied in an area where θβ is less than 45°, a superior noise control performance is provided, and even in the event that the condition on θα in condition 1) is satisfied in an area where θβ is more than 45°, a superior noise control performance is also provided, the cross grooves should be designed to satisfy the condition on θα in 1) in the area where θβ is less than 45° while satisfying the condition on θα in 2) an area where θβ is equal to or more than 45° and less than 60° when the upper limit and the lower limit of θα are taken into consideration.

Incidentally, in passenger car tires, in particular, passenger car tires with small aspect ratios (for example, tires with an aspect ratio of 55% or less), as is clear from the contact patch shaping line S shown in FIG. 1, θβ becomes 60° or more in most ranges of a contact width. Due to this, the cross grooves 12 are disposed so that the cross grooves 12 have the point of intersection A in the area of 60°≦θβ≦90° defined under 3), and are preferably formed so that the crossing angle θα becomes larger than 105° or satisfies the condition 3) above.

The cross grooves 12 can be provided only in the area 1) where θβ<45° or only in the area 2) where 45°≦θβ<60°, and in either of the cases, the cross grooves 12 may be formed so as to satisfy the individual conditions on θα. Furthermore, these areas 1) to 3) may be properly combined to configure a tread pattern.

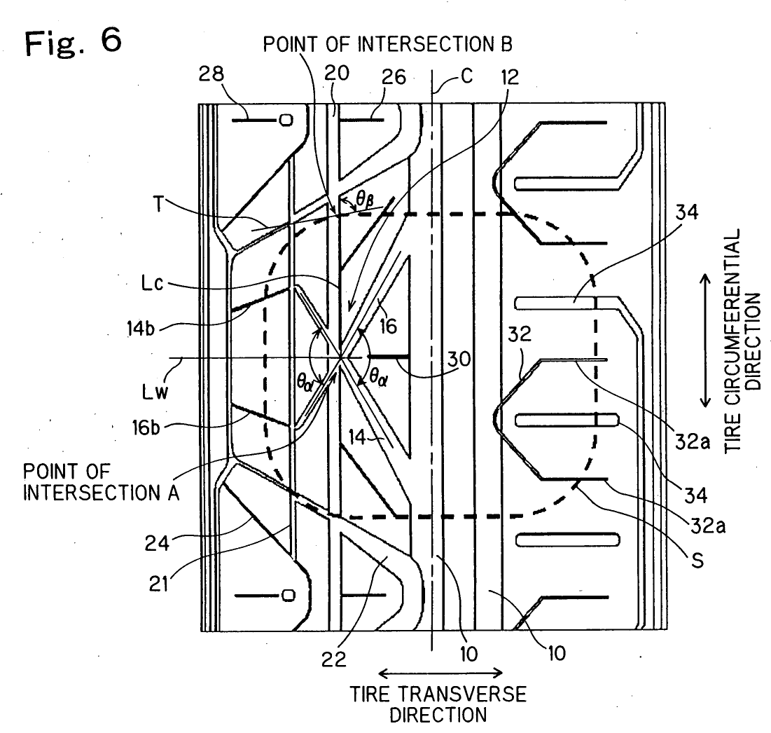

FIG. 6 is a planar development of part of a tread pattern of a pneumatic tire according a second embodiment of the invention. In this embodiment, an example is shown in which the cross grooves 12 are provided in only on one side of the tread portion in the transverse direction of the tire so as to provide a tread pattern which asymmetrical with respect to a tire transverse center line C.

To be specific, two circumferential main grooves 10 are provided at a transversely central portion of a tread portion in parallel and slightly offset relative to the tire transverse center line C. In addition, the cross grooves 12 are provided in such a manner as to open to the main groove 10 provided on the tire transverse center line C, and sipes 14b, 16b are provided at respective distal end portions of a first grove 14 and a second groove 16 which make up the cross grooves 12 in such a manner as to be bent outwards in the transverse direction of the tire. These sipes 14b, 16b incline inwards in such a manner that a gap therebetween slightly narrows as they extend towards respective distal end portions.

In addition, in this example, in order to increase the performance when running straight ahead, a circumferential groove 20 extending in the circumferential direction of the tire is provided in such a manner as to cross the cross grooves 12 at a point of intersection A of the gross grooves 12. Also in this event where the tread pattern has the circumferential groove 20 which crosses the cross grooves 12 in the vicinity of the points of intersection A, the noise control performance can be increased by setting θα and θβ as described above. Incidentally, in the illustrated example, an inner θα is 116.9° and an outer θα is 115.8°, and θβ is set to 80°. The other configurations related to the cross grooves 12 are similar to those of the first embodiment, and the description thereof will be omitted here.

In addition, in this example, a circumferential thin groove 21 which extends in the circumferential direction of the tire is provided in such a manner as to cross connecting portions between the first groove 14 and the second groove 16 and the sipes 14b, 16b of the cross grooves 12. Additionally, V-shaped grooves 22 which are each made to open into a V shape outwards in the transverse direction of the tire are provided alternately with the cross grooves 12, and a sipe 24 which is made to open into a V shape outwards in the transverse direction of the tire is provided in an area lying outwards of the V-shaped groove 22 in the transverse direction of the tire. Moreover, sipes 26, 28 which extend in the transverse direction of the tire are provided inside of these V-shaped groove 22 and sipes 24, respectively. In addition, a sipe 30 is provided in an area inside of the cross grooves 12 in the transverse direction of the tire in such a manner as to open to the main groove 10.

On the other hand, in an opposite area to the cross grooves 12 in the transverse direction of the tire, a plurality of sipes 32 which are each made to open into a V shape outwards in the transverse direction of the tire are provided in the circumferential direction of the tire, and transverse sipes 32a, 32a are provided at both ends of the V-shaped sipe 32 which are bent outwards in the transverse direction of the tire so as to extend in parallel in the transverse direction of the tire. Additionally, a transverse groove 34 which extends in the transverse direction of the tire is provided between the two transverse sipes 32a, 32a which lie adjacent to each other in the circumferential direction.

### EXAMPLES 1 TO 3

On the basis of the tread pattern shown in FIG. 1, pneumatic radial tires of Examples 1 to 3 and Comparison Examples 1 to 4 were prepared in which the distance between the point of intersection A and the tire transverse center line C was changed to thereby changes θβ as shown in Table 1 below, and θα was set as shown in Table 1, the other configurations remaining the same. A tire size used was 225/45R17.

The individual tires so obtained were measured with respect to water drainage properties and noise control performance using the following method.

Water Drainage Properties: the individual tires were mounted on a passenger car (sedan) of an engine displacement of 2500 cc, and the vehicle was run on a wet road surface with a water depth of 8 mm. An sensory evaluation was made on the existence of hydroplaning phenomenon during the running, and the results were evaluated using Example 1 as a base index of 100. A larger value means more superior water drainage properties.

Noise Control Performance: A bench noise test was carried out on each single tire (under a running speed of 60 km/h, a load of 420 kgf which corresponds to an actually loaded vehicle, a tire inflation pressure of 220 kPa), and noise levels were measured using a microphone set 1 m away from the center of the tire at a height of 0.25 m according to C606-81 of JASO (Japanese Automobile Standards Organization).

The results are shown in Table 1, and with Examples 1 to 3 which were prepared according to the invention, the noise levels could be reduced without sacrificing the water drainage properties.

TABLE 1

| | Distance between | | | | Noise |
|---|---|---|---|---|---|
| | Point of | | | | Control |
| | Intersection A | | | | Performance |
| | and Tire | | | Water | Patter |
| | Transverse | | | Drainage | Noise |
| | Center Line (mm) | θα(°) | θβ(°) | Properties | Level (dB) |
| Example 1 | 20.0 | 120.0 | 85.0 | 100.0 | 76.0 |
| Example 2 | 55.0 | 125.0 | 55.0 | 100.5 | 75.0 |
| Example 3 | 65.0 | 55.0 | 40.0 | 99.5 | 76.5 |
| Comparison | 20.0 | 80.0 | 85.0 | 99.0 | 79.0 |
| Example 1 | | | | | |
| Comparison | 40.0 | 100.0 | 70.0 | 99.5 | 78.0 |
| Example 2 | | | | | |
| Comparison | 55.0 | 112.0 | 50.0 | 99.5 | 80.0 |
| Example 3 | | | | | |
| Comparison | 65.0 | 120.0 | 40.0 | 100.5 | 78.0 |
| Example 4 | | | | | |

### EXAMPLES 4, 5

On the basis of the tread pattern shown in FIG. 6, pneumatic tires of Examples 4, 5 and Comparison Examples 5 to 7 were prepared in which θα and θβ were set as shown in Table 2 and the other configurations were the same. A tire size of 225/45ZR17 was used.

The individual tires so obtained were measured with respect to water drainage properties and noise control performance using the same method as that used for Examples 1 to 3. In addition, the water drainage properties were evaluated using Example 4 as a base index of 100. A larger value means more superior water drainage properties.

The results are shown in Table 2, and with Examples 4, 5 which were prepared according to the invention, the noise levels could be reduced without sacrificing the water drainage properties.

TABLE 2

| | Distance between | | | | Noise |
|---|---|---|---|---|---|
| | Point of | | | | Control |
| | Intersection A | | | | Performance |
| | and Tire | | | Water | Patter |
| | Transverse | | | Drainage | Noise |
| | Center Line (mm) | θα(°) | θβ(°) | Properties | Level (dB) |
| Example 4 | 55.0 | 110.0 | 70.0 | 100.0 | 73.5 |
| Example 5 | 55.0 | 125.0 | 85.0 | 100.5 | 72.5 |
| Comparison | 55.0 | 90.0 | 85.0 | 98.5 | 75.5 |
| Example 5 | | | | | |
| Comparison | 55.0 | 100.0 | 85.0 | 99.0 | 74.5 |
| Example 6 | | | | | |
| Comparison | 55.0 | 100.0 | 70.0 | 99.5 | 74.0 |
| Example 7 | | | | | |

What is claimed is:

1. A pneumatic tire comprising cross grooves which are provided on a tread portion of the tire in such a manner as to cross each other in an X shape, as well as cross each other substantially symmetrically with respect to a tire transverse line, wherein assuming that a point of intersection between a tire circumferential line which passes through a point of intersection A of the cross grooves and a tire contact patch shaping line is a point of intersection B, a crossing angle of the cross grooves which lie to hold therebetween a tire transverse line which passes through the point of intersection A is θα, and an angle made by a tire circumferential line which passes through the point of intersection B and a tangential line to the tire contact patch shaping line at the point of intersection B is θβ, the cross grooves are provided to satisfy 60°≦θβ≦90° and θα>105°.

2. A pneumatic tire as set forth in claim 1, wherein the cross angle θα of the cross grooves is not more than 150°.

3. A pneumatic tire as set forth in claim 1, wherein a circumferential groove extending in a circumferential direction of the tire is provided in the tread portion, and wherein the cross grooves are provided in such a manner as to be made to open to the circumferential groove and are provided in a plural number at predetermined intervals in the circumferential direction of the tire.

4. A pneumatic tire as set forth in claim 3, wherein the cross grooves are made up of a first groove which extends outwards in a transverse direction of the tire from the circumferential groove in an inclined fashion and a second groove which extends outwards in the transverse direction of the tire from the circumferential groove in such a manner as to be inclined in an opposite direction to the first groove so as to cross the first groove.

5. A pneumatic tire as set forth in claim 4, wherein transverse groove portions or sipes which are bent outwards in the transverse direction of the tire to extend in the transverse direction of the tire are provided at respective distal end portions of the first groove and the second groove.

6. A pneumatic tire comprising cross grooves which are provided on a tread portion of the tire in such a manner as to cross each other in an X shape, as well as cross each other substantially symmetrically with respect to a tire transverse line, wherein assuming that a point of intersection between a tire circumferential line which passes through a point of intersection A of the cross grooves and a tire contact patch shaping line is a point of intersection B, a crossing angle of the cross grooves which lie to hold therebetween a tire transverse line which passes through the point of intersection A is θα, and an angle made by a tire circumferential line which passes through the point of intersection B and a tangential line to the tire contact patch shaping line at the point of intersection B is θβ, the cross grooves are provided in at least one of the following areas defined 1) to 3) below and have a crossing angle θα which satisfies expressions given for the areas where the grooves are provided:
area of θβ<45°: θα<−2.5×θβ+162.5° 1)
area of 45°≦θβ<60°: θα>−1.2×θβ+179° 2)
area of 60°≦θβ≦90°: θα>105° 3)

7. A pneumatic tire as set forth in claim 6, wherein the cross angle θα of the cross grooves is not less than 30° and not more than 150°.

8. A pneumatic tire as set forth in claim 6, wherein a circumferential groove extending in a circumferential direction of the tire is provided in the tread portion, and wherein the cross grooves are provided in such a manner as to be made to open to the circumferential groove and are provided in a plural number at predetermined intervals in the circumferential direction of the tire.

9. A pneumatic tire as set forth in claim 8, wherein the cross grooves are made up of a first groove which extends outwards in a transverse direction of the tire from the circumferential groove in an inclined fashion and a second groove which extends outwards in the transverse direction of the tire from the circumferential groove in such a manner as to be inclined in an opposite direction to the first groove so as to cross the first groove.

10. A pneumatic tire as set forth in claim 9, wherein transverse groove portions or sipes which are bent outwards in the transverse direction of the tire to extend in the transverse direction of the tire are provided at respective distal end portions of the first groove and the second groove.
